(19) United States
(12) Patent Application Publication
(10) Pub. No.: US 2026/0295993 A1
(43) Pub. Date: Oct. 1, 2026

(54) INKJET PRINTING APPARATUS, CONTROL METHOD, AND NON-TRANSITORY COMPUTER-READABLE STORAGE MEDIUM STORING A PROGRAM

(71) Applicant: Konica Minolta, Inc., Tokyo (JP)

(72) Inventor: Takashi MUKAIYAMA, Tokyo (JP)

(21) Appl. No.: 19/578,465

(22) Filed: Mar. 25, 2026

(30) Foreign Application Priority Data
Mar. 31, 2025 (JP) 2025-059176

(51) Int. Cl. B41J 2/045; B41J 11/00; B41J 29/377

(52) U.S. Cl. CPC B41J 2/04515; B41J 2/04581; B41J 11/00214; B41J 11/007; B41J 29/377

(57) ABSTRACT

Provided is an inkjet printing apparatus that includes: an image former that includes an inkjet head and an emitter; a flow rate measurer that measures a flow rate of a cooling medium that cools the emitter; and a hardware processor that controls the image former based on the measured flow rate. The inkjet head ejects ink, which is cured by emission of an active ray, onto a recording medium, and the emitter emits the active ray to the ink to cause the ink to be cured.

### CROSS REFERENCE TO RELATED APPLICATIONS

The entire disclosure of Japanese Patent Application No. 2025-059176, filed on Mar. 31, 2025, is incorporated herein by reference in its entirety.

### BACKGROUND

### Technological Field

The present invention relates to an inkjet printing apparatus, a control method, and a non-transitory computer-readable storage medium storing a program.

### DESCRIPTION OF RELATED ART

There is known an inkjet printing apparatus which forms an image on a recording medium by ejecting ink droplets from a nozzle of an inkjet head.

In the inkjet printing apparatus, an inkjet head ejects ultraviolet curable ink, which is cured by emission of ultraviolet rays, onto a recording medium, and an emitter emits ultraviolet rays to the ink on the recording medium to fix the ink, thereby forming an image.

In such an inkjet printing apparatus, the emitter is configured to emit ultraviolet rays with an ultraviolet light emitting diode (UVLED). When the emitter is continuously driven for a long time, the temperature of the emitter, specifically, the UVLED increases. When the temperature of the UVLED increases, emission efficiency may decrease, uniform emission of ultraviolet rays may not be performed, and suitable image formation may not be performed. For this reason, for example, Japanese Patent Application Laid-Open No. 2012-240219 (hereinafter referred to as “PTL 1”) deals with the problems described above by detecting the temperature of the emitter and stopping the emission by the emitter to stop the image formation processing.

However, in PTL 1, the emitter in a heated state is detected and then the emission by the emitter, that is, the lighting of the UVLED is stopped, and thus, there is a problem in that thermal stress is applied to the emitter, deterioration of elements progresses, and the life is shortened as well.

In addition, since the lighting of the emitter is stopped after the heated emitter is detected, there is a problem in that the ink which has already been ejected onto the recording medium by the inkjet head is not cured by the emitter, and thus, the ink is in an uncured state. When the recording medium having the uncured ink adhered thereto is conveyed in the apparatus, there is a problem in that the ink adheres to the inside of the apparatus to contaminate the apparatus itself and contaminate another recording medium to be printed next.

### SUMMARY

An object of the present invention is to provide an inkjet printing apparatus, a control method, and a non-transitory computer-readable storage medium storing a program each capable of preventing deterioration of an emitter and performing image formation suitably.

An inkjet printing apparatus reflecting one aspect of the present invention in order to achieve at least one of the above-described objects includes:

an image former that includes an inkjet head, which ejects ink onto a recording medium, and an emitter, which emits an active ray to the ink to cause the ink to be cured, where the ink is cured by emission of the active ray;

a flow rate measurer that measures a flow rate of a cooling medium that cools the emitter; and

a hardware processor that controls the image former based on the measured flow rate.

A control method reflecting one aspect of the present invention includes, in an inkjet printing apparatus including an image former that includes an inkjet head, which ejects ink onto a recording medium, and an emitter, which emits an active ray to the ink to cause the ink to be cured, where the ink is cured by emission of the active ray by the inkjet head, executing:

measuring, by a flow rate measurer, a flow rate of a cooling medium that cools the emitter; and

controlling the image former based on the measured flow rate.

A non-transitory computer-readable storage medium storing a program reflecting one aspect of the present invention causes a computer of an inkjet printing apparatus including:

an image former that includes an inkjet head, which ejects ink onto a recording medium, and

an emitter, which emits an active ray to the ink to cause the ink to be cured; and a flow rate measurer that measures a flow rate of a cooling medium that cools the emitter, where the ink is cured by emission of the active ray,

to execute control of the image former based on the measured flow rate.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of a printing apparatus according to an embodiment of the present invention;

FIG. 2 is a schematic diagram illustrating the configuration of a head unit of the printing apparatus according to an embodiment of the present invention;

FIG. 3 is a block diagram illustrating a main functional configuration of the printing apparatus according to an embodiment of the present invention;

FIG. 4 is a schematic diagram illustrating the configuration of a main part of the printing apparatus according to an embodiment of the present invention;

FIG. 5 is a flowchart provided for describing control of the printing apparatus according to an embodiment of the present invention; and

FIG. 6 is a flowchart provided for describing another control of the printing apparatus according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, a preferred embodiment of the present disclosure will be described in detail with reference to the accompanying drawings. Note that, in the present specification and drawings, constituent elements having substantially the same functions are denoted by the same reference signs, and redundant description thereof will be omitted.

### Overall Configuration of Inkjet Printing Apparatus

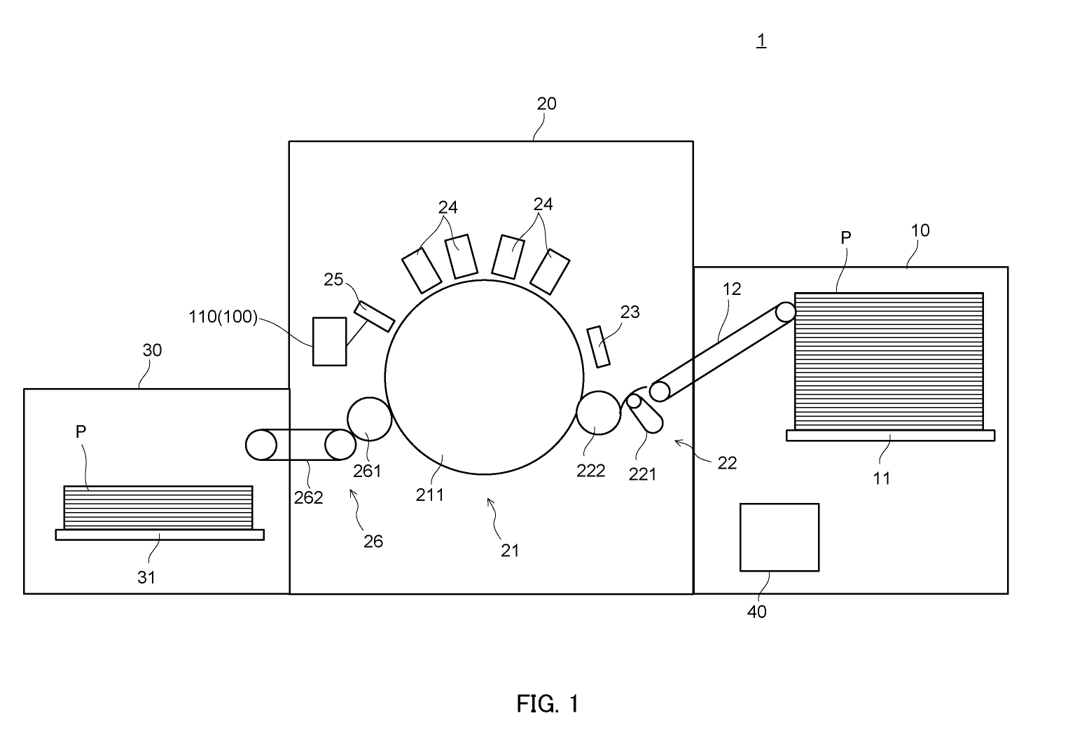

Hereinafter, the configuration of an inkjet printing apparatus 1 according to an embodiment of the present invention will be described with reference to FIG. 1 to FIG. 3.

FIG. 1 is a diagram illustrating a schematic configuration of the inkjet printing apparatus 1 according to the present embodiment. The inkjet printing apparatus 1 includes a sheet feed section 10, an image former 20, a sheet ejection section 30, and a control section 40.

The inkjet printing apparatus 1, under the control of the control section 40, conveys a recording medium P accommodated in the sheet feed section 10 to the image former 20, ejects ink onto the recording medium P at the image former 20 to record an image thereon, and conveys the recording medium P including the image recorded thereon to the sheet ejection section 30. Specifically, the inkjet printing apparatus 1 records a color image on the recording medium P by outputting each of four colors of yellow (Y), magenta (M), cyan (C), and black (K) with a predetermined number of recording gradations on the recording medium P in a superposed manner. Note that, as the recording medium P, in addition to plain paper or coated paper, various media can be used on which ink having landed on the surface can be fixed, such as fabric or sheet-like resin.

The sheet feed section 10 includes a sheet feed tray 11 that accommodates the recording medium P, and a medium supply section 12 that conveys and supplies the recording medium P from the sheet feed tray 11 to the image former 20. The medium supply section 12 includes a ring-shaped belt whose inner side is supported by two rollers, and rotates the rollers, in a state in which the recording medium P is placed on the belt, to convey the recording medium P from the sheet feed tray 11 to the image former 20.

The image former 20 includes a conveyor 21, a handover unit 22, a heating section 23, a head unit 24, an emitter 25, and a delivery section 26.

The conveyor 21 holds the recording medium P placed on a conveyance surface of a conveyance drum (rotary body) 211 having a cylindrical shape. The conveyor 21 conveys the recording medium P on the conveyance drum 211 in a conveyance direction along the conveyance surface as a conveyance drum 211 circulates and moves around its rotation shaft (cylindrical shaft) extending in the width direction of the recording medium P.

The conveyance drum 211 includes a claw section (not illustrated) and a suction section (not illustrated) for holding the recording medium P on the conveyance surface. The recording medium P is held on the conveyance surface by being pressed at an end portion of the recording medium P by the claw section and by being sucked to the conveyance surface by the suction section.

The handover unit 22 is provided at a position between the medium supply section 12 of the sheet feed section 10 and the conveyor 21, and holds one end of the recording medium P conveyed from the medium supply section 12 with a swing arm section 221 to pick the recording medium P up, and then hands over the recording medium P to the conveyor 21 via a handover drum 222.

The heating section 23 is provided between the arrangement position of the handover drum 222 and the arrangement position of the head unit 24, and heats the recording medium P so that the recording medium P conveyed by the conveyor 21 has a temperature within a predetermined range. The heating section 23 includes, for example, an infrared ray heater or the like, and energizes the infrared ray heater on the basis of a control signal supplied from the control section 40 to cause the infrared ray heater to generate heat.

The head unit 24 records an image by ejecting ink onto the recording medium P from opening portions of nozzles 243 provided on an ink ejection surface facing the conveyance surface of the conveyance drum 211 at an appropriate timing corresponding to the rotation of the conveyance drum 211 on which the recording medium P is held. The ink ejected from the nozzle 243 onto the recording medium P is cured by emission of light. Specifically, the ink is ink (for example, ultraviolet (UV) curable ink) having a property of being cured by emission of active rays (for example, ultraviolet rays). Note that, the UV ink is ink, which contains an active ray polymerizable compound and in which the active ray polymerizable compound is polymerized and crosslinked by emission of active rays to cause the ink to be cured. In addition, the active ray curable ink may contain, if necessary, a polymerization initiator, a gelling agent, a polymerization inhibitor, a color material such as a dye and a pigment, a dispersant for dispersing pigments, a fixing resin for fixing a pigment to a base material, a surfactant, a pH-adjusting agent, a humectant, an ultraviolet absorber, and the like.

The head unit 24 includes a plurality of inkjet heads 240, and is disposed so that the ink (droplet) ejection surface of the inkjet head 240 and the conveyance surface are separated from each other by a predetermined distance. The inkjet head 240 ejects ink, which is cured by emission of active rays, onto the recording medium P.

In the inkjet printing apparatus 1 of the present embodiment, four head units 24 corresponding to inks of the four colors of Y, M, C, and K, respectively, are arranged at predetermined intervals in the order of the colors of Y, M, C, and K from the upstream side in the conveyance direction of the recording medium P. That is, the head units 24 are configured to be capable of ejecting a plurality of types of inks different from each other.

In the inkjet printing apparatus 1, the head unit 24 is used with the position thereof being fixed at the time of image recording, and sequentially ejects ink at predetermined intervals (intervals in the conveyance direction) to different positions in the conveyance direction according to the conveyance of the recording medium P, to record an image in a single-pass manner.

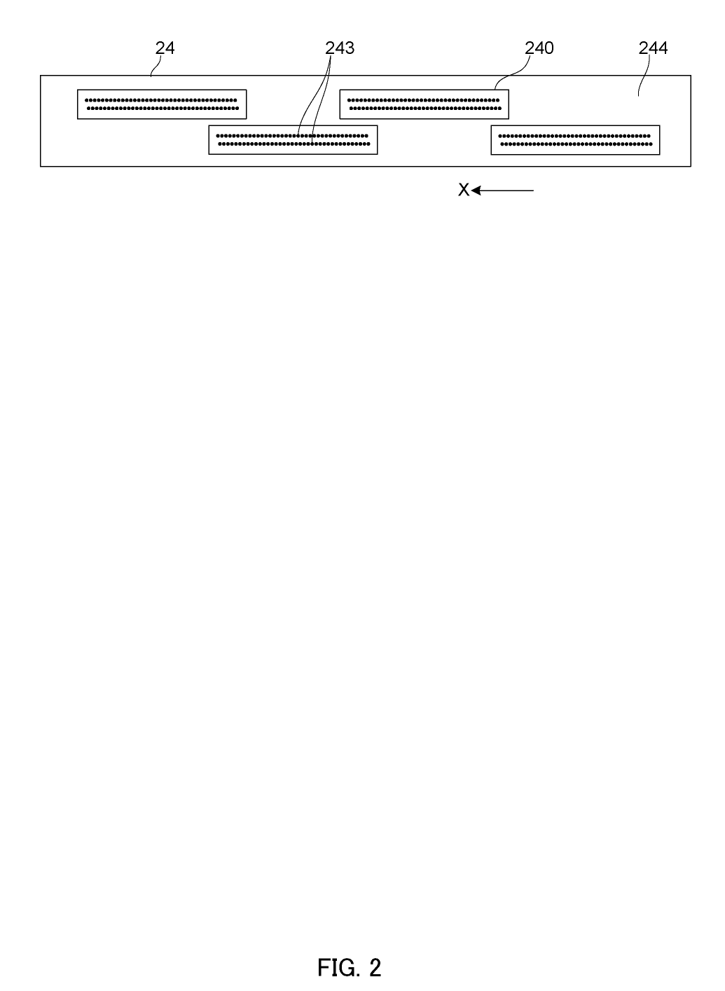

FIG. 2 is a schematic diagram illustrating the configuration of the head unit 24 according to the present embodiment. FIG. 2 illustrates a surface of the head unit 24, which faces the outer periphery surface of the conveyance drum 211.

Here, the head unit 24 includes four inkjet heads 240 attached to an attachment member 244. Each of the inkjet heads 240 is provided with a plurality of image forming elements each including a pressure chamber (not illustrated) that stores ink, a piezoelectric element (not illustrated) provided on a wall surface of the pressure chamber, and a nozzle 243. In the image forming element, when a drive signal for deforming and operating the piezoelectric element is inputted, the deformation of the piezoelectric element deforms the pressure chamber to change the pressure in the pressure chamber, thereby ejecting ink from the nozzle 243 communicating with the pressure chamber.

The four inkjet heads 240 are arranged in a houndstooth check pattern so that the arrangement ranges of nozzle rows in the X direction (representing a direction orthogonal to the conveyance direction; the same applies hereinafter) are connected without a break. The arrangement ranges of the nozzles 243 included in the head unit 24 in the X direction cover the width of a region of the recording medium P in the X direction, where the region of the recording medium P is a region on which an image is formed, and the recording medium P is conveyed by the conveyance drum 211. The head unit 24 is used in a fixed manner relative to the rotation shaft of the conveyance drum 211 at the time of image formation. That is, the head unit 24 constitutes a line head capable of ejecting ink over an image formable width of the recording medium P in the X direction.

The inkjet head 240 includes an ink heating section (not illustrated) that heats ink stored in the inkjet head 240, and ejects ink that has been heated and becomes sol-like. When the sol-like ink is ejected onto the recording medium P, the ink droplets are landed on the recording medium P and then naturally cooled, so that the ink quickly becomes gel-like and solidified on the recording medium P.

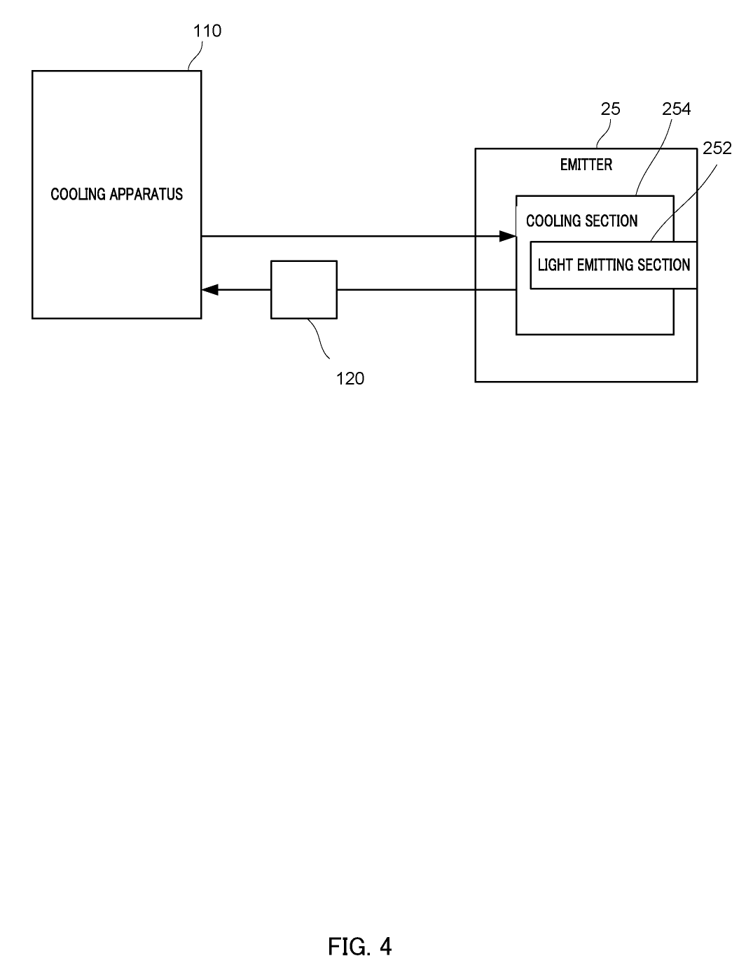

The emitter 25 includes a light emitting section 252 (see FIG. 4) disposed over the width of the conveyor 21 in the direction orthogonal to the conveyance direction. The emitter 25 applies predetermined energy to the ink (gel ink) ejected onto the recording medium P by emitting active energy rays, such as ultraviolet rays, from the light emitting section to the recording medium P placed on the conveyance drum 211, to cause the ink to be cured and fixed.

The emitter 25 emits electromagnetic waves (for example, ultraviolet rays having a wavelength of 395 nm) to the recording medium P placed on the conveyor 21 to cause the ink, which has been ejected onto the recording medium P, to be cured and fixed.

The light emitting section 252 (see FIG. 4) of the emitter 25 is disposed to face the conveyance surface between the arrangement position of the head unit 24 and the arrangement position of the handover drum 261 (the delivery section 26) in the conveyance direction. Note that, the detailed configuration of the emitter 25 will be described later.

The delivery section 26 includes a belt loop 262, whose inner side is supported by two rollers and which includes a ring-shaped belt, and a handover drum 261 having a cylindrical shape, which hands over the recording medium P from the conveyor 21 to the belt loop 262. The delivery section 26 causes the belt loop 262 to convey the recording medium P, which has been handed over from the conveyor 21 onto the belt loop 262 by the handover drum 261, and sends out the recording medium P to the sheet ejection section 30.

The sheet ejection section 30 includes a sheet ejection tray 31 which has a plate shape and on which the recording medium P fed out from the image former 20 by the delivery section 26 is placed.

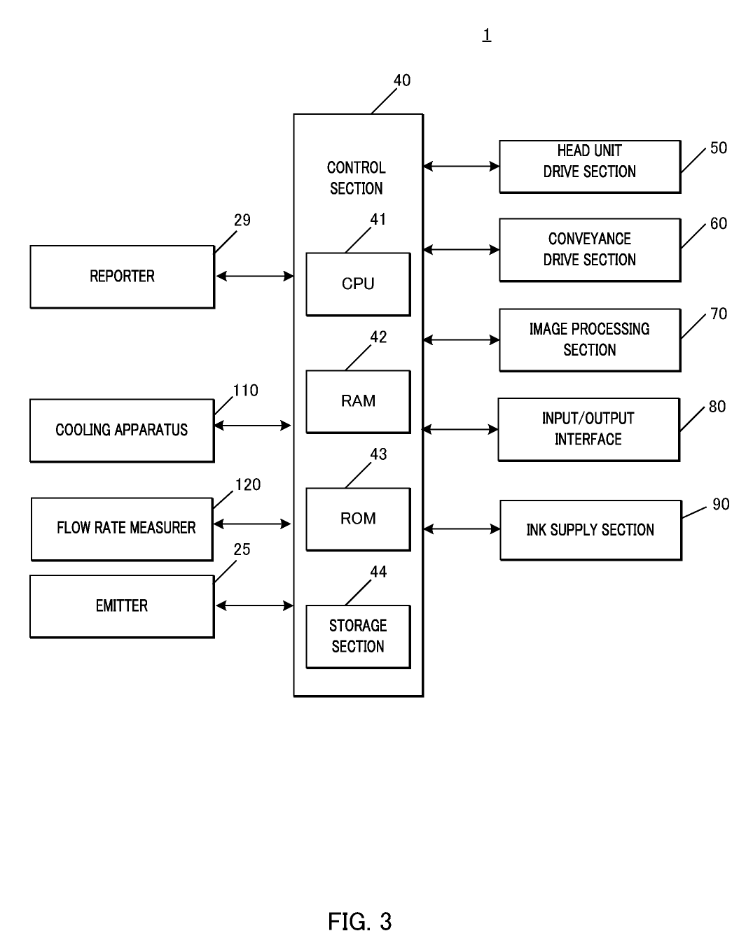

FIG. 3 is a block diagram illustrating a main functional configuration of the inkjet printing apparatus 1 according to the present embodiment. The inkjet printing apparatus 1 includes the control section 40, a head unit drive section 50, a conveyance drive section 60, an image processing section 70, an input/output interface 80, an ink supply section 90, a cooling apparatus 110, a flow rate measurer 120, the emitter 25, and a reporter 29.

The control section 40 is, for example, a computer including at least one hardware processor. The control section 40 includes a central processing unit (CPU) 41, a random access memory (RAM) 42, a read only memory (ROM) 43, and a storage section 44, and comprehensively controls the entire operation of the inkjet printing apparatus 1. The CPU 41 reads a control program from a storage section such as the ROM 43, develops the control program in the RAM 42, and centrally control the operation of each block constituting the inkjet image printing apparatus 1 in cooperation with the developed control program. In the case of the present embodiment, as will be described below, the control section 40 executes an image former control program, which is included in the control program, for controlling the image former based on the flow rate of a cooling medium that cools the emitter. The image former control program is accommodated in a non-transitory computer-readable recording medium, and is stored in the storage section from the recording medium.

The control section 40 is connected to the flow rate measurer 120 and controls the driving of the head unit 24 via the head unit drive section 50 based on the flow rate (information on the flow rate) of the cooling medium circulating from the cooling apparatus 110 to the emitter 25. The cooling medium may be a liquid such as a coolant liquid, or a cooling gas, as long as the cooling medium can cool the light emitting section 252.

The control section 40 controls each section according to an inputted print job and causes an image to be formed on the recording medium P correspondingly to the print job.

In particular, the control section 40 controls the emitter 25 so that the emitter 25 emits energy rays to the ink which has been ejected onto the recording medium P by the head unit 24.

The control section 40 controls the cooling apparatus 110, which is a chiller, so that the emitter 25 does not receive stress due to heating or overheating accompanied by driving, and detects the flow rate of the cooling medium which is sent out from the cooling apparatus 110 to the emitter 25 and is measured. The control section 40 causes the emitter 25 to be cooled based on the measured flow rate, and prevents an increase in the temperature of the light emitting section 252 and further the emitter 25 itself by overheating due to the emission driving.

The control section 40 determines whether the chiller flow rate is a predetermined flow rate. The predetermined flow rate is a flow rate at which the emitter 25, more specifically, the light emitting section 252, such as a UVLED, is cooled to a temperature at which thermal stress is not applied thereto. Thus, it is possible to prevent deterioration of elements of the light emitting section 252, such as a UVLED, from progressing and prevent the life from being shortened.

The control section 40 controls the entire image formation processing, in particular, the operation of the image former 20, based on the predetermined flow rate. The control section 40 controls the emission output of the emitter 25 and controls the driving of the conveyor 21 and the head unit 24.

For example, in a case where the chiller flow rate measured by the flow rate measurer 120 during the printing operation is smaller than the predetermined flow rate, that is, in a case where the flow rate is a flow rate at which the light emitting section 252 cannot be sufficiently cooled, the control section 40 stops the driving of the emitter 25, that is, the emission by the light emitting section 252. In other words, the control section 40 performs the printing processing in a case where the chiller flow rate is equal to or greater than the predetermined flow rate, that is, in a case where the flow rate at which the light emitting section 252 can be sufficiently cooled. In addition, the control section 40 also stops the ejection of ink by the head unit 24. The recording medium P onto which the ink has been ejected may be held on the conveyance route (conveyance route section) under the control of the control section 40. That is, the control section 40 can cause the recording medium P to be in a state in which the recording medium P is temporarily stopped on the conveyance route section and can cause the emission to be restarted in a case where the chiller flow rate returns to a flow rate equal to or greater than the predetermined flow rate. Thus, the control section 40 is capable of causing no uncured ink to be conveyed in the image former 20, makes it possible to cause a range, in which the inside of the image former 20 is contaminated due to the adhesion of ink, to be minimized, and makes it unnecessary to clean the inside of the image former 20. In addition, the control section 40 stops the feed of the recording medium P by the sheet feed section 10.

Note that, the control section 40 can cause the recording medium P remaining in the image former 20 to be discharged from the conveyance route.

In addition, the control section 40 causes, based on the information on the chiller flow rate acquired via the flow rate measurer 120, the conveyance drive section 60 to decrease the conveyance speed of the recording medium P, in particular, by controlling the driving of the conveyance drum 211.

The head unit drive section 50 supplies a drive signal corresponding to image data to the recording element of the head unit 24 at an appropriate timing based on the control of the control section 40. Thus, the head unit drive section 50 causes the nozzle 243 of the head unit 24 to eject ink in an amount corresponding to the pixel value of the image data.

The conveyance drive section 60 supplies a drive signal to a conveyance drum motor provided in the conveyance drum 211 on the basis of a control signal supplied from the control section 40 and rotates the conveyance drum 211 at a predetermined speed and timing. In addition, the conveyance drive section 60 supplies a drive signal to motors for operating the medium supply section 12, the handover unit 22, and the delivery section 26 based on a control signal supplied from the control section 40, and causes the recording medium P to be supplied to the conveyor 21 and causes the recording medium P to be discharged from the conveyor 21.

The image processing section 70 performs predetermined image processing on image data inputted through the input/output interface 80, and stores the obtained image data in the storage section 44. The image processing includes, in addition to correction processing for correcting image data, color conversion processing, gradation correction processing, pseudo halftone processing, and the like.

The input/output interface 80 is connected to an input/output interface of an external apparatus (for example, a personal computer) and mediates transmission and reception of data between the control section 40 and the external apparatus. The input/output interface 80 is constituted by, for example, various serial interfaces, various parallel interfaces, or a combination thereof.

The ink supply section 90 supplies ink, which is stored in an ink tank (not illustrated), to each of the plurality of inkjet heads 240 provided in the head unit 24. The ink supply section 90 adjusts the amount of ink to be supplied to each of the plurality of inkjet heads 240 according to a control signal from the control section 40.

The reporter 29 reports the printing status of the inkjet printing apparatus 1 to the user, and is constituted by, for example, a speaker that generates a sound, a display that displays an image, and the like. Note that, the reporter 29 may use an operation panel for inputting a print job. The control section 40 causes the reporter 29 to broadcast control information of the image former 20 based on the flow rate of the cooling medium. Specifically, in a case where the flow rate of the cooling medium is a flow rate at which the light emitting section 252 cannot be cooled, the reporter 29 notifies the user to that effect or notifies the user of the operation processing of the image former 20 thereby.

### Cooling Mechanism of Emitter 25

FIG. 4 is a schematic diagram illustrating the configuration of a main part of the printing apparatus according to an embodiment of the present invention, which illustrates the configuration of a main part of a cooling mechanism of the emitter of the inkjet printing apparatus.

The cooling mechanism is a mechanism for suppressing heat generation due to the driving of the emitter 25, enabling an emission operation and a suitable emission output, and performing suitable image formation processing.

The cooling mechanism includes: a cooling section 254 that cools the light emitting section 252 of the emitter 25; the cooling apparatus 110 that is connected to the cooling section 254 and supplies the cooling medium to the cooling section 254; the flow rate measurer 120; and a circulation route section (channel). The circulation route section connects the cooling section 254 and the cooling apparatus 110 and causes the cooling medium to flow from the cooling apparatus 110 to the cooling section 254 to cool the light emitting section 252, and the cooling medium that has cooled the light emitting section 252 returns from the cooling section 254 to the cooling apparatus 110 and circulates through the circulation route section.

The cooling apparatus 110 supplies the cooling medium to the cooling section 254 via the circulation route section.

The circulation route section connects the cooling apparatus 110 and the cooling section 254, causes the cooling medium cooled by the cooling apparatus 110 to be sent out to the cooling section 254, and causes the cooling medium to circulate so that the cooling medium returns from the cooling section 254 to the cooling apparatus 110.

In the circulation route section, the flow rate measurer 120 is provided on the way from the cooling section 254 back to the cooling apparatus 110.

The flow rate measurer 120 measures the flow rate of the cooling medium which flows through the attached circulation route section and cools the emitter 25, and outputs the measured flow rate as chiller flow rate information to the control section 40. The cooling medium is, for example, a liquid, and cools the light emitting section 252 by a liquid cooling method. The flow rate measurer 120 is disposed downstream of the emitter 25 in the circulation route section of the cooling medium, and is therefore capable of measuring the actual temperature at the time of cooling the light emitting section 252 and is capable of detecting the state of the light emitting section 252 immediately (timely).

In the emitter 25, a UVLED or the like is applied as the light emitting section 252, and the cooling section 254 is configured to cool the UVLED with the cooling medium. For example, the cooling section 254 is a pipeline disposed adjacent to the light emitting section 252 and having a high thermal conductivity, prevents a temperature increase of the light emitting section 252 by causing the cooling medium to flow therein, and decreases the temperature of the light emitting section 252 so that the light emitting section 252 does not generate heat.

The cooling medium that has absorbed the heat of the light emitting section 252 returns to the cooling apparatus 110 through the circulation route section, is cooled again, and is sent out to the cooling section 254.

The circulation route section is constituted by, for example, piping formed by a hose or a pipe.

Next, drive control of the emitter in the inkjet printing apparatus according to the present embodiment will be described.

### Control of Image Former 20

The image former 20, in particular, the emitter 25 is controlled by the control section 40 executing a program stored in the storage section 44. For example, the storage section 44 stores a temperature at which the light emitting section 252 receives thermal stress due to heat generation, that is, a temperature at which deterioration progresses and the life is shortened. In addition, the storage section 44 stores the flow rate of the cooling medium, at which the light emitting section 252 can be sufficiently cooled so as not to reach these temperatures, as predetermined values (for example, a first predetermined value and a second predetermined value) in advance according to the size and the basis weight of the sheet.

Thus, by configuring so that the printing is not started (lighting control of the emitter is not performed) when the measured flow rate of the cooling medium is a flow rate equal to or less than the predetermined flow rate, the control section 40 can preliminarily prevent a state in which sufficient cooling cannot be performed by the cooling medium.

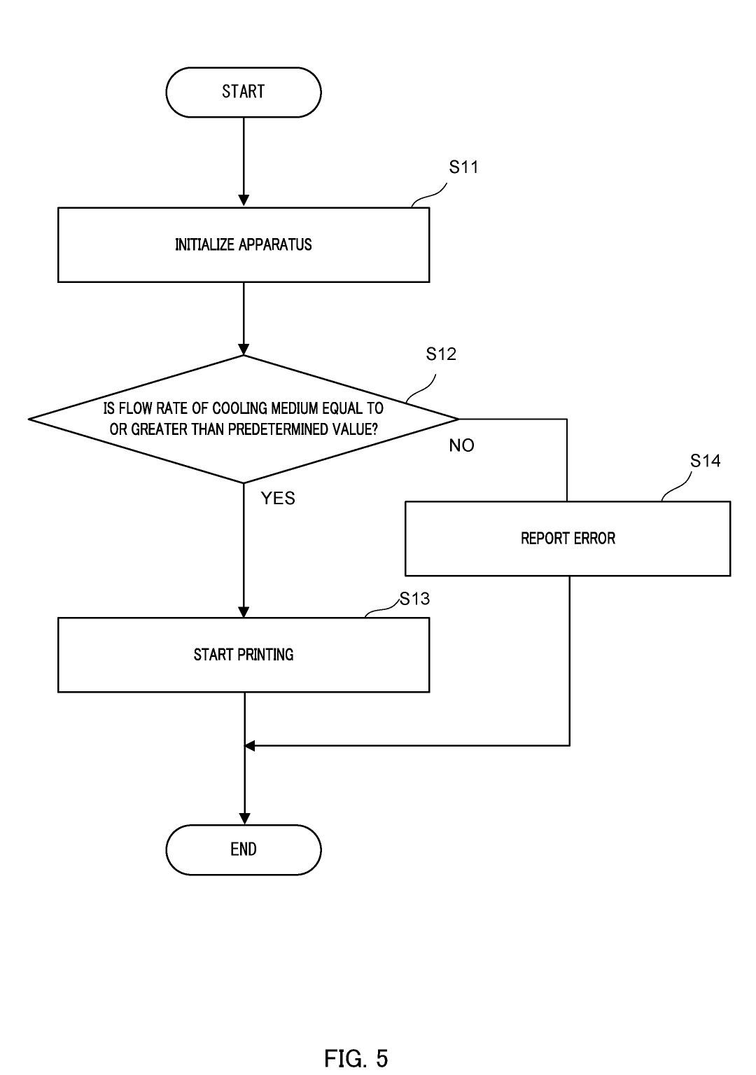

FIG. 5 is a flowchart provided for describing control of the printing apparatus according to an embodiment of the present invention. As illustrated in FIG. 5, in step S11, the control section 40 first initializes each setting for driving the emitter 25 in the inkjet printing apparatus, for example, a measurement value and the like, and drives each section. For example, the control section 40 drives each section, that is, the head unit drive section 50, the conveyance drive section 60, the image processing section 70, the ink supply section 90, and the like, on the basis of a print job.

In the cooling mechanism, the control section 40 drives the cooling apparatus 110 and the emitter 25, and causes the flow rate measurer 120 to start to measure the flow rate of the cooling medium flowing through the circulation route section.

In step S12, the control section 40 performs detection as to whether the flow rate of the cooling medium measured via the flow rate measurer 120 is equal to or greater than a predetermined amount indicated by a predetermined value. The predetermined value is a flow rate at which the light emitting section 252 of the emitter 25 can surely be cooled.

In step S12, in a case where the flow rate of the cooling medium that the cooling apparatus 110 causes to flow to the emitter 25 is equal to or greater than the predetermined value (YES), the control section 40 determines that the flow rate of the cooling medium is a flow rate at which the light emitting section 252 can be sufficiently and surely cooled, and proceeds to step S13. On the other hand, when the control section 40 determines in step S12 that the measured flow rate of the cooling medium is less than the predetermined value (NO), the control section 40 proceeds to step S14.

In step S13, the control section 40 causes each section in the image former 20 to start the printing processing corresponding to the print job.

In step S14, the control section 40 reports, to the user, information on the flow rate, that is, that the flow rate is a flow rate at which the light emitting section 252 cannot be cooled. For example, the control section 40 reports an error by sound and display using a sound section (speaker) (not illustrated) and/or a display section such as a display (not illustrated).

In addition, the control section 40 may stop the processing, image formation, ink curing, and the like at the image former 20 after reporting an error. In addition, the control section 40 may report an error by stopping the processing, image formation, ink curing, and the like at the image former 20.

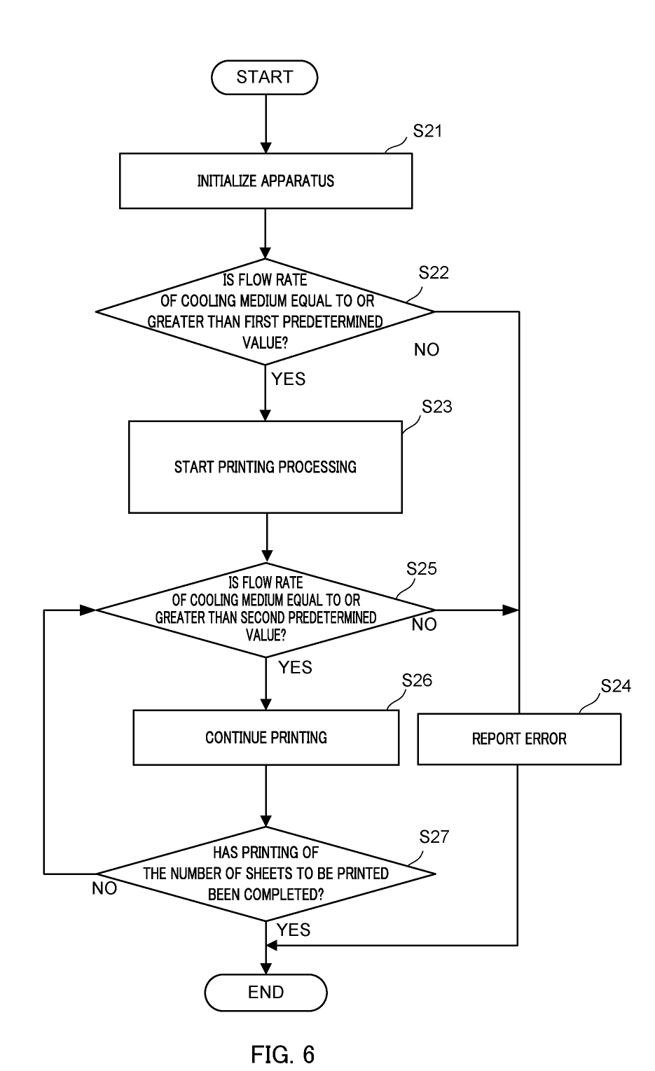

FIG. 6 is a flowchart provided for describing another control of the printing apparatus according to an embodiment of the present invention.

As illustrated in FIG. 6, in step S21, the control section 40 first initializes each setting for driving the emitter 25 in the inkjet printing apparatus, for example, a measurement value and the like, and drives each section. For example, the control section 40 drives each section, that is, the head unit drive section 50, the conveyance drive section 60, the image processing section 70, the ink supply section 90, and the like, on the basis of a print job.

In the cooling mechanism, the control section 40 drives the cooling apparatus 110 and the emitter 25, and causes the flow rate measurer 120 to start to measure the flow rate of the cooling medium flowing through the circulation route section.

In step S22, the control section 40 performs detection, via the flow rate measurer 120, as to whether the flow rate of the cooling medium is equal to or greater than a first predetermined amount indicated by a first predetermined value.

The first predetermined value (the first predetermined amount) is a value indicating a flow rate at which the light emitting section 252 of the emitter 25 can surely be cooled. Immediately after the start of printing, the diving does not occur at the time of the start of driving of the light emitting section 252 and the temperature of the light emitting section 252 itself is low. That is, it takes time for the temperature of the light emitting section 252 itself to reach a temperature at which thermal stress occurs, as compared with the time of the driving, and it is not necessary to cool the light emitting section 252. For this reason, the first predetermined value is a value indicating a flow rate smaller than the flow rate of the cooling medium required to cool the light emitting section 252 to a temperature at which it receives thermal stress during operation, and heating or overheating can be suppressed even when the light emitting section 252 is cooled at a low flow rate.

In step S22, when the flow rate of the cooling medium is equal to or greater than the first predetermined value (YES), the control section 40 determines that the flow rate of the cooling medium is a flow rate at which the light emitting section 252 can be sufficiently and surely cooled, and proceeds to step S23, whereas when the flow rate of the cooling medium is less than the first predetermined value (NO), the control section 40 proceeds to step S24.

In step S23, the control section 40 causes each section in the image former 20 to start printing processing corresponding to the print job, and proceeds to step S25.

In step S24, the control section 40 reports, to the user, information on the flow rate, that is, that the flow rate is a flow rate at which the light emitting section 252 cannot be cooled. For example, the control section 40 reports an error by sound and display using a sound section (speaker) (not illustrated) and a display panel such as a display (not illustrated).

In step S24, the control section 40 may stop the processing, image formation, ink curing, and the like at the image former 20 after reporting an error. In addition, the control section 40 may report an error by stopping the processing, image formation, ink curing, and the like at the image former 20.

In step S25, the control section 40 performs detection, via the flow rate measurer 120, as to whether the flow rate of the cooling medium is equal to or greater than a second predetermined amount indicating a second predetermined value.

The second predetermined value (the second predetermined amount) is a flow rate at which the light emitting section 252 of the emitter 25 can surely be cooled after the start of the printing processing. The second predetermined flow rate is a flow rate at which the light emitting section 252 is cooled at a predetermined flow rate (value) greater than the previously set predetermined flow rate when the emitter 25 is being driven so as to be heated or overheated during printing after the start of printing.

For example, this flow rate value is a value indicating the flow rate of the cooling medium for maintaining an appropriate temperature even when the temperature increases due to heat generation according to the number and size (sheet size) of sheets serving as the recording medium P in the emitter 25.

The determination using the second predetermined value indicating the second predetermined amount involves control so that the emitter 25, that is, the light emitting section 252 is not heated or overheated correspondingly to a case where the flow rate is a flow rate equal to or greater than the second predetermined amount after a predetermined time, a case where the flow rate is a flow rate equal to or greater than the second predetermined amount before the printing of a predetermined number of sheets to be printed is completed, or the like.

That is, in step S25, the control section 40 determines whether the measured flow rate of the cooling medium is equal to or greater than the flow rate indicated by the second predetermined value which is equal to or greater than the first predetermined amount indicated by the first predetermined value.

In step S25, when the flow rate of the cooling medium is equal to or greater than the second predetermined value (YES), the control section 40 determines that the flow rate of the cooling medium is a flow rate at which the light emitting section 252 can be sufficiently and surely cooled. In step S25, when the flow rate of the cooling medium is less than the second predetermined value (NO), the control section 40 proceeds to step S24.

In step S26, the control section 40 causes each section in the image former 20 to continue the printing processing corresponding to the print job, and proceeds to step S27.

In step S27, the control section 40 determines whether the printing processing of the number of sheets to be printed has been completed, and in a case where the printing processing of the number of sheets to be printed has been completed, the control section 40 stops the print job, whereas when the printing processing of the number of sheets to be printed has not been completed, the control section 40 returns to step S25 and causes the processing to be repeated.

In a case where the sheet size is small, in a case where the number of sheets to be printed is small, or the like, the light emitting section 252 is cooled by intermittently turning on the lighting or stopping the lighting, and thus, the temperature thereof decreases.

The control section 40 can decrease the flow rate of the cooling medium to be supplied to the cooling section 254 in order to cool the light emitting section 252 in a state where the temperature thereof is decreased according to the time, the number of sheets, a case where the sheet size is small, or the like.

As described above, the control section 40 drives each section in the image former 20 based on the flow rate of the cooling medium for surely cooling the light emitting section 252 according to the time, the number of sheets, or the sheet size.

When the power of the image former 20 is on, that is, when the image former 20 is supplied with power and is in a drivable state, the control section 40 causes the flow rate measurer 120 to continuously measure the flow rate of the cooling medium and controls the operation of the image former 20 based on the measured flow rate.

In addition, the control section 40 may control the operation of the inkjet printing apparatus 1 based on the acquired information on the flow rate of the cooling medium in response to the inkjet printing apparatus 1 starting the image formation processing. In addition, the control section 40 may acquire information on the flow rate of the cooling medium and may control the operation of the inkjet printing apparatus 1 based on the information while the inkjet printing apparatus 1 is executing the image formation processing.

Examples of the operation of the inkjet printing apparatus 1 based on the flow rate include, in addition to the operation in which the control section 40 causes the reporter 29 to report to that effect and the operation in which the control section 40 stops the driving of the emitter 25, that is, the operation in which the control section 40 stops the emission by the light emitting section 252, the following operations.

The control section 40 may perform control based on the acquired information on the flow rate of the cooling medium to perform an operation of prohibiting the ejection of the UV curable ink from the nozzle 243 of the head unit 24.

The control section 40 may prohibit, based on the flow rate of the cooling medium acquired during the printing operation, the ejection of the UV curable ink from the nozzles 243 of the head unit 24, for example, when the acquired flow rate is equal to or less than a predetermined amount indicated by a predetermined value of the flow rate. In addition, at the same time, the control section 40 may stop the sheet supply from the medium supply section 12 and causes the recording medium P remaining in the conveyance to be held therein. Thus, after an abnormality in the flow rate of the cooling medium is eliminated, that is, in a case where the flow rate of the cooling medium returns to a flow rate equal to or greater than the predetermined flow rate, it is possible to restart the printing by driving each section in the image former 20 as appropriate, such as driving the emitter 25 to cause the light emitting section 252 to restart the emission. Accordingly, at the image former 20, no recording medium P on which uncured ink has been ejected is conveyed, no uncured ink adheres to the inside of the image former 20, and the inside of the image former 20 is not contaminated.

The control section 40 may perform an operation of causing the conveyance drum 211 as the conveyor to decrease the conveyance speed of the recording medium P according to the flow rate of the cooling medium. In a case where the output control of the emitter 25 (the light emitting section 252) is decreased, the ink on the recording medium P is not cured when the conveyance speed is the same.

Accordingly, by causing the conveyance drum 211 to decrease the conveyance speed of the recording medium P, it is possible to ensure the emission time (integrated light amount) for the ink. For example, in a case where a small amount of leakage of the cooling medium occurs, the control section 40 changes the control so that thermal stress is not applied to the light emitting section 252, such as a UVLED, by decreasing the output control of the emitter 25.

In addition, the control section 40 prohibits, based on the flow rate of the cooling medium, the conveyance of the recording medium to the downstream side of the conveyance drum 211. In a case where the measured flow rate of the cooling medium is a flow rate at which the light emitting section 252 cannot be cooled to a temperature at which the light emitting section 252 does not receive thermal stress, the control section 40 controls the conveyance drum 211 so that the conveyance of the recording medium to the downstream side from the conveyance drum 211 is stopped. Additionally, the control section 40 controls the emission output of the light emitting section 252. Thus, the recording medium P on which uncured ink has been ejected is outputted as an unfinished product and is prevented from being outputted as a finished product.

In addition, the control section 40 may cause the rotation of the conveyance drum 211 to be continued for a predetermined time when prohibiting the conveyance of the recording medium P to downstream of the conveyance drum 211. Thus, no recording medium P with uncured ink flows to the downstream side to contaminate the conveyance path or the like.

According to the inkjet printing apparatus 1, the printing is started and the ink is cured after it is detected that the light emitting section 252, such as a UVLED, of the emitter 25 is appropriately cooled, and thus, it is possible to prevent deterioration of the light emitting section 252 (UVLED) and to perform the printing suitably. As described above, according to the inkjet printing apparatus 1, it is possible to prevent deterioration of the emitter and to appropriately perform image formation.

Although specific examples of the present invention have been described in detail above, these are merely specific examples and do not limit the scope of the claims. The technology described in the claims includes various variations and alterations of the specific examples illustrated above.

Although embodiments of the present invention have been described and illustrated in detail, the disclosed embodiments are made for purpose of illustration and example only and not limitation. The scope of the present invention should be interpreted by terms of the appended claims.

What is claimed is:

1. An inkjet printing apparatus, comprising:
an image former that includes an inkjet head and an emitter, the inkjet head ejecting ink onto a recording medium, the emitter emitting an active ray to the ink to cause the ink to be cured, the ink being cured by emission of the active ray;
a flow rate measurer that measures a flow rate of a cooling medium that cools the emitter; and
a hardware processor that controls the image former based on the measured flow rate.

2. The inkjet printing apparatus according to claim 1, wherein
when the image former is supplied with power and is in a drivable state, the hardware processor causes the flow rate measurer to continuously measure the flow rate.

3. The inkjet printing apparatus according to claim 1, wherein
the hardware processor causes the flow rate to be measured and controls the image former in response to a start of image formation processing of the image former.

4. The inkjet printing apparatus according to claim 1, wherein
the hardware processor causes the flow rate to be measured and controls the image former while the image former is executing image formation processing.

5. The inkjet printing apparatus according to claim 1, wherein
the hardware processor stops ejection of the ink from the inkjet head based on the flow rate.

6. The inkjet printing apparatus according to claim 5, further comprising:
a supplier that supplies the recording medium to the inkjet head;
a conveyor that conveys the recording medium; and
a conveyance route through which the conveyor conveys the recording medium from the supplier to inkjet head and the emitter in this order, wherein
the hardware processor stops, based on the flow rate, the ejection of the ink, stop supply of the recording medium from the supplier to the inkjet head, and causes the conveyor to hold the recording medium remaining in the conveyance route.

7. The inkjet printing apparatus according to claim 6, wherein
the hardware processor causes, based on the flow rate, the conveyor to decrease a conveyance speed of the recording medium from the inkjet head to the emitter.

8. The inkjet printing apparatus according to claim 7, wherein:
the conveyor includes a rotary body that rotates with the recording medium placed on an outer periphery surface of the rotary body and conveys the recording medium from the supplier to the inkjet head and the emitter in this order, and
the hardware processor stops, based on the flow rate, conveyance of the recording medium from the supplier.

9. The inkjet printing apparatus according to claim 8, wherein
the hardware processor causes, based on the flow rate, rotation of the rotary body to be continued for a predetermined time.

10. The inkjet printing apparatus according to claim 1, wherein
the flow rate measurer measures the flow rate of the cooling medium after the emitter is cooled.

11. The inkjet printing apparatus according to claim 1, further comprising a reporter that reports to a user, wherein
the hardware processor causes the reporter to report control of the image former based on the flow rate to the user.

12. The inkjet printing apparatus according to claim 10, wherein
the hardware processor controls, during printing, an emission output of the emitter according to the flow rate.

13. A non-transitory computer-readable storage medium storing a program, which causes a computer of an inkjet printing apparatus including:
an image former that includes an inkjet head and an emitter; and
a flow rate measurer that measures a flow rate of a cooling medium that cools the emitter, the inkjet head ejecting ink onto a recording medium, the emitter emitting an active ray to the ink to cause the ink to be cured, the ink being cured by emission of the active ray,
to execute control of the image former based on the measured flow rate.

14. A control method, comprising, in an inkjet printing apparatus including an image former that includes an inkjet head and an emitter, the inkjet head ejecting ink onto a recording medium, the emitter emitting an active ray to the ink to cause the ink to be cured, the ink being cured by emission of the active ray by the inkjet head, executing:
measuring, by a flow rate measurer, a flow rate of a cooling medium that cools the emitter; and
controlling the image former based on the measured flow rate.
